(19) United States
(12) Patent Application Publication
(10) Pub. No.: US 2008/0267425 A1
(43) Pub. Date: Oct. 30, 2008

(54) Method of Measuring Annoyance Caused by Noise in an Audio Signal

(75) Inventors: Nicolas Le Faucheur, Rospez (FR); Valerie Gautier-Turbin, Louannec (FR)

Correspondence Address: COHEN, PONTANI, LIEBERMAN & PAVANE LLP, 551 FIFTH AVENUE, SUITE 1210, NEW YORK, NY, 10176, US

(73) Assignee: France Telecom, Paris (FR)

(21) Appl. No.: 11/884,573

(22) PCT Filed: Feb. 13, 2006
(86) PCT No.: PCT/FR06/50126

§ 371 Date: Oct. 29, 2007

(30) Foreign Application Priority Data
Feb. 18, 2005 (FR) 0501747

(51) Int. Cl. H04B 15/00

(52) U.S. Cl. 381/94.1

(57) ABSTRACT

A method of computing an objective score (NOB) of annoyance caused by noise in an audio signal processed by a noise reduction function, said method including a preliminary step of obtaining a predefined test audio signal (x[m]) containing a wanted signal free of noise, a noisy signal (xb[m]) obtained by adding a predefined noise signal to said test signal (x[m]), and a processed signal (y[m]) obtained by applying the noise reduction function to said noisy signal (xb[m]), wherein said method further includes a step (a3, a4) of measuring the apparent loudness of frames of said noisy signal (xb[m]) and said processed signal (y[m]) and of measuring tonality coefficients of frames of said processed signal (y[m]).

The general fields of the present invention are speech signal processing and psychoacoustics. More precisely, the invention relates to a method and to a device for objectively evaluating annoyance caused by noise in audio signals.

In particular the invention objectively scores annoyance caused by noise in an audio signal processed by a noise reduction function.

In the field of audio signal transmission, the objective of a noise reduction function, also called a noise suppression function or denoising function, is to reduce the level of background noise in a voice call or in a call having one or more voice components. It is of specific benefit if one of the parties to the call is in a noisy environment that strongly degrades the intelligibility of that party's voice. Noise reduction algorithms are based on continuously estimating the background noise level from the incident signal and on detecting voice activity to distinguish periods of noise alone from periods in which the wanted speech signal is present. The incident speech signal corresponding to the noisy speech signal is then filtered to reduce the contribution of noise determined from the noise estimate.

The annoyance caused by noise in an audio signal processed by this kind of noise reduction function is at present evaluated only subjectively by processing results of tests conducted in accordance with ITU-T Recommendation P.835 (11/2003). Such evaluation is based on an MOS (Mean Opinion Score) type scale that assigns a score from one to five to the annoyance caused by noise, which is referred to as “background noise” in the above document.

The major drawback of that evaluation technique is the necessity to use subjective tests, which represents a heavy workload and is very costly. Each particular context, i.e. a particular incident signal type associated with a particular noise type and a particular noise reduction function, requires a panel of people who actually listen to speech samples and who are asked to score the annoyance caused by the noise on a MOS-type scale.

For this reason there is great interest in developing alternative methods that are objective and that can complement or supplant subjective methods. The most striking illustration of this phenomenon is the constantly evolving listening quality model set out in ITU-T Recommendation P.862 (02/2001). That model is not applied to evaluating annoyance caused by noise, however. The invention relates to speech signals in which the annoyance caused by noise can be high, before or after the signals are processed by a noise reduction function.

Note also that, although the invention will generally be used to evaluate the annoyance caused by noise at the output of communication equipment implementing a noise reduction function, the invention also applies to noisy signals that are not processed by any such function. Using the invention on any noisy audio signal is thus a special case of the more general case of using the invention on an audio signal processed by a noise reduction function.

An object of the present invention is to remove the drawbacks of the prior art by providing a method and a device for objectively computing a score equivalent to the subjective score specified in ITU-T Recommendation P.835 characterizing the annoyance caused by noise in an audio signal. The method of the invention varies, in particular in terms of the parameters for computing the objective score in accordance with the invention, depending on whether the invention is used on any noisy audio signal or on an audio signal processed by a noise reduction function. In order to describe these two uses clearly, two embodiments that might also be regarded as two separate methods are described. However, the second embodiment, which is applicable to any noisy audio signal and is more general than the first embodiment, is readily deduced therefrom.

To this end, the invention proposes a method of computing an objective score of annoyance caused by noise in an audio signal processed by a noise reduction function, said method including a preliminary step of obtaining a predefined test audio signal containing a wanted signal free of noise, a noisy signal obtained by adding a predefined noise signal to said test signal, and a processed signal obtained by applying the noise reduction function to said noisy signal, said method being characterized in that it includes a step of measuring the apparent loudness of frames of said noisy signal and said processed signal and of measuring tonality coefficients of frames of said processed signal.

This method has the advantage over subjective tests that it is simple, immediate, and fast. The expression “psychoacoustic apparent loudness” may be defined as the character of the auditory sensation linked to the sound pressure level and to the structure of the sound. In other words, it is the strength of the auditory sensation caused by a sound or a noise (cf. Office de la langue francaise 1988). Apparent loudness (expressed in sones) is represented on a psychoacoustic apparent loudness scale. Apparent loudness density, also known as “subjective intensity”, is one particular measurement of apparent loudness.

According to a preferred feature of the method of the invention, it includes the steps of:
computing mean apparent loudness densities S̅_{Y}(m) of frames of the processed signal (y[m]), respective mean apparent loudness densities S̅_{Xb}(m_speech) and S̅_{Y}(m_speech) of frames of the wanted signal “m_speech” respectively of the noisy signal and of the processed signal, mean apparent loudness densities S̅_{Y}(m_noise) of noise frames “m_noise” of the processed signal, and tonality coefficients a_{Y}(m_noise) of noise frames “m_noise” of the processed signal; and
computing an objective score of annoyance caused by noise in the processed signal from said mean apparent loudness densities and said tonality coefficients that have been computed and predefined weighting coefficients.

According to a preferred feature, the step of computing mean apparent loudness densities and tonality coefficients is followed by a step of computing mean values S̅_{Y}, S̅_{Xb}_{_{—}}speech, S̅_{Y}_{_{—}}speech, S̅_{Y}_{_{—}}noise, and a_{Y}_{_{—}}noise of said mean apparent loudness densities and said tonality coefficients over the set of frames concerned of the corresponding signals and the objective score of annoyance caused by noise is computed using the following equation:

$$N O B = {\sum }_{i = 1}^{5} {ω}_{i} factor ( i ) + {ω}_{6}$$

$$where \text{:}$$

$$factor ( 1 ) = \frac{{\overline{S}}_{Y} \_noise}{{\overline{S}}_{Y}} ;$$

$$factor ( 2 ) = \frac{{\overline{S}}_{Y} \_noise}{{\overline{S}}_{Y} \_speech} ;$$

factor(3)=SD( S̅_{Xb}(m_speech)− S̅_{Y}(m_speech)), the operator “SD(v(m))” denoting the standard deviation of the variable v over the set of frames m;

factor(4)=a_{Y}_{_{—}}noise;

factor(5)=SD(a_{Y}(m_noise)); and

the coefficients ω₁ to ω₆ are determined to obtain a maximum correlation between subjective data obtained from a subjective test database and the objective scores computed by said method of the test, noisy, and processed signals used during said subjective tests.

The advantage of the coefficients of this linear combination is that they can be recomputed if new subjective test data significantly modifies the correlation previously established. This enhances an objective model fed by the method of the invention of computing annoyance caused by noise in an audio signal processed by a noise reduction function merely by reconfiguring the parameters of the method.

The invention also relates to a method of computing an objective score of annoyance caused by noise in an audio signal, said method including a preliminary step of obtaining a predefined test audio signal containing a wanted signal free of noise and a noisy signal obtained by adding a predefined noise signal to said test signal, said method being characterized in that it includes a step of measuring apparent loudness and tonality coefficients of frames of said noisy signal.

This method has the same advantages as the previous method, but applies to any noisy audio signal.

According to a preferred feature of this method of the invention, it includes the steps of:
computing mean apparent loudness densities S̅_{Xb}(m) of frames of the noisy signal, mean apparent loudness densities S̅_{Xb}(m_speech) of wanted signal frames “m_speech” of the noisy signal, mean apparent loudness densities S̅_{Xb}(m_noise) of noise frames “m_noise” of the noisy signal, and tonality coefficients a_{Xb}(m_noise) of noise frames “m_noise” of the noisy signal; and
computing an objective score of annoyance caused by noise in the noisy signal from said mean apparent loudness densities and said tonality coefficients that have been computed and predefined weighting coefficients.

According to a preferred feature, the step of computing mean apparent loudness densities and tonality coefficients is followed by a step of computing mean values S̅_{Xb}, S̅_{Xb}_{_{—}}speech, S̅_{Xb}_{_{—}}noise and a_{Xb}_{_{—}}noise of said mean apparent loudness densities and said tonality coefficients over the set of frames concerned of the corresponding signals and said objective score of annoyance caused by noise is computed using the following equation:

$$N O B = {\sum }_{i = 1}^{4} {ω}_{i} factor ( i ) + {ω}_{5}$$

$$in which \text{:}$$

$$factor ( 1 ) = \frac{{\overline{S}}_{Xb} \_noise}{{\overline{S}}_{Xb}} ;$$

$$factor ( 2 ) = \frac{{\overline{S}}_{Xb} \_noise}{{\overline{S}}_{Xb} \_speech} ;$$

$$factor ( 3 ) = {α}_{Xb} \_noise ;$$

factor(4)=SD(a_{Xb}(m_noise)), the operator “SD (v(m))” denoting the standard deviation of the variable v over the set of frames m; and
the coefficients ω₁ to ω₅ are determined to maximize the correlation between subjective data obtained from a subjective test database and the objective scores computed by said method of the test signals and the corresponding noisy signals used in said subjective tests.

As for the preceding method, the advantage of the coefficients of this linear combination is that they can be recomputed if new subjective test data significantly modifies the correlation previously established. This enhances an objective model fed by the method of the invention of computing annoyance caused by noise in an audio signal merely by reconfiguring the parameters of the method.

According to a preferred feature of both these methods of the invention said step of computing apparent loudness densities and tonality coefficients is preceded by a step of detecting voice activity in the test signal to determine if a current frame of the noisy signal and of the processed signal in the first method is a frame “m_noise” containing only noise or a frame “m_speech” containing speech, called the wanted signal frame.

This voice activity detection step is a very simple way of using the test signal to separate the different types of frames of the noisy signal, and of the processed signal in the first method.

According to a preferred feature of both these methods of the invention, the step of computing the objective score is followed by a step of computing an objective score on the MOS scale of annoyance caused by noise using the following equation:

$$NOB\_MOS = {\sum }_{i = 1}^{4} {{λ}_{i} ( N O B )}^{i - 1}$$

in which the coefficients λ₁ to λ₄ are determined so that said new objective score obtained characterizes annoyance caused by noise on the MOS scale.

Using a third order polynomial function yields an objective score on the MOS scale that is very close to the subjective score MOS that would be given by a panel of listeners in a subjective test in accordance with ITU-T Recommendation P.835.

According to a preferred feature of both these methods of the invention, in the step of computing apparent loudness densities and tonality coefficients, computing the mean apparent loudness density S̅_{U}(m) of a frame with any index m of a given audio signal u includes the following steps:
windowing, for example Hanning-type windowing, the frame with index m to obtain a windowed frame u_w[m];
applying a fast Fourier transform to the windowed frame u_w[m] to obtain a corresponding frame U(m,f) in the frequency domain;
computing the spectral power density γ_{U}(m,f) of the frame U(m,f);
converting the power spectral density γ_{U}(m,f) from a frequency axis to a Barks scale to obtain a spectral power density B_{U}(m,b) on the Barks scale;
convoluting the spectral power density B_{U}(m,b) on the Barks scale with the spreading function routinely used in psychoacoustics to obtain a spread spectral density E_{U}(m,b) on the Barks scale;
calibrating the spread spectral density E_{U}(m,b) on the Barks scale by respective power spreading and apparent loudness spreading factors routinely used in psychoacoustics, converting the magnitude thus obtained to the phons scale and then converting the magnitude previously converted into phons to the sones scale, and consequently obtaining a number B of apparent loudness density values S_{U}(m,b) of the frame with index m for the critical band b, where B is the number of critical bands concerned on the Barks scale and the index b varies from 1 to B; and
computing the mean apparent loudness density S̅_{U}(m) of the frame with index m from said B apparent loudness density values S_{U}(m,b), using the following equation:

$${\overline{S}}_{U} ( m ) = \frac{1}{B} {\sum }_{b = 1}^{B} {S}_{U} ( m , b )$$

According to a preferred feature of both these methods of the invention, in the step of computing apparent power densities and tonality coefficients, computing the tonality coefficient a(m) of a frame with any index m of a given audio signal u includes the following steps:
windowing, for example Hanning-type windowing, the frame with index m to obtain a windowed frame u_w[m];
applying a fast Fourier transform to the windowed frame u_w[m] to obtain a corresponding frame U(m,f) in the frequency domain;
computing the spectral power density γ_{U}(m,f) of the frame U(m,f);
computing the tonality coefficient a(m) using the following equation:

$$α ( m ) = \frac{10 * log 10 ( \frac{{( {\prod }_{f = 0}^{N - 1} {γ}_{U} ( m , f ) )}^{1 / N}}{\frac{1}{N} {\sum }_{f = 0}^{N - 1} {γ}_{U} ( m , f )} )}{- 60}$$

in which * symbolizes the multiplication operator in the real number space, f represents the frequency index of the spectral power density, and N designates the size of the fast Fourier transform.

The invention further relates to test equipment characterized in that it includes means adapted to implement either of the methods of the invention to evaluate an objective score of the annoyance caused by noise in an audio signal.

According to a preferred feature, the test equipment includes electronic data processing means and a computer program including instructions adapted to execute either of said methods when it is executed by said electronic data processing means.

The invention further relates to a computer program on an information medium including instructions adapted to execute either of the methods of the invention when the program is loaded into and executed in an electronic data processing system.

The advantages of the above test equipment or the above computer program are identical to those referred to above in relation to the methods of the invention.

Other features and advantages become apparent on reading the description of preferred embodiments given with reference to the figures, in which:

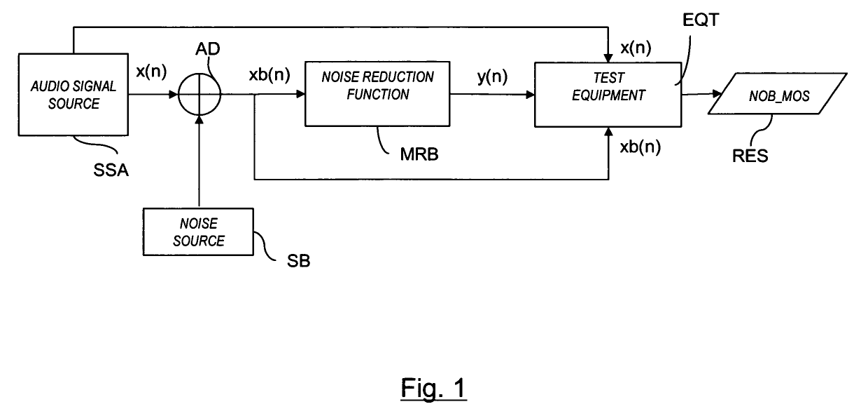

FIG. 1 represents a test environment for computing in accordance with a first embodiment of the invention an objective score of the annoyance caused by noise in an audio signal processed by a noise reduction function;

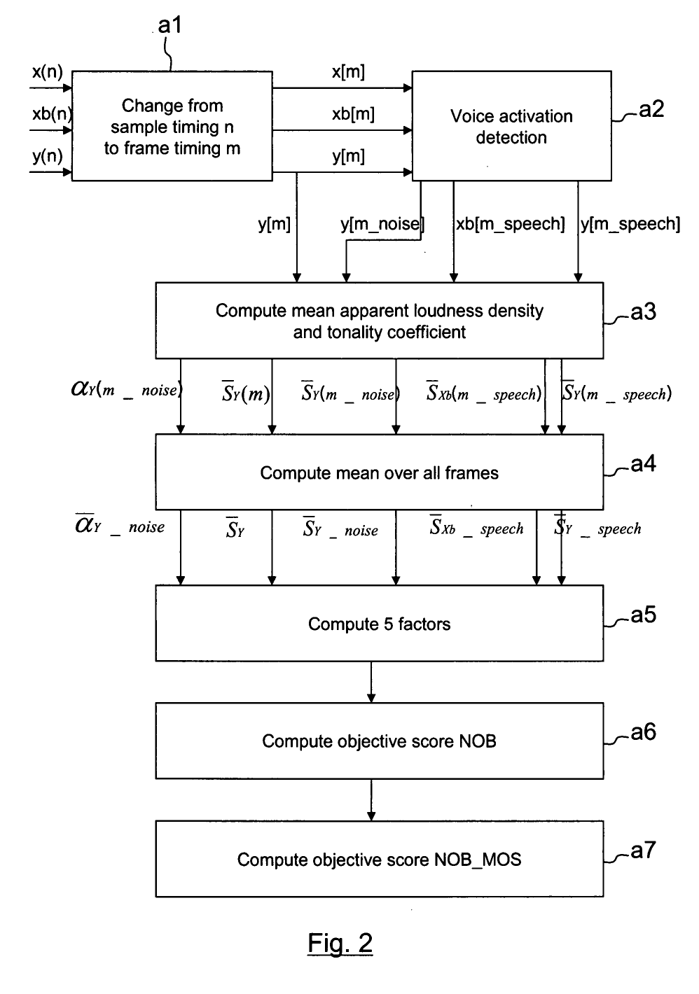

FIG. 2 is a flowchart illustrating a first embodiment of a method of the invention for computing an objective score of the annoyance caused by noise in an audio signal processed by a noise reduction function;

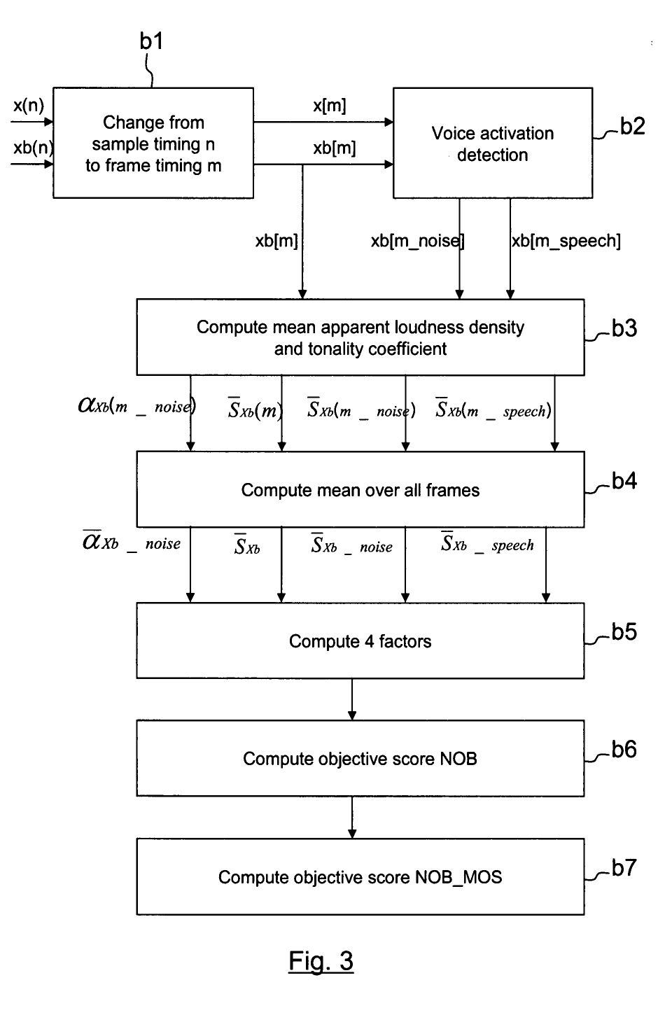

FIG. 3 is a flowchart illustrating a method of computing in accordance with a second embodiment of a method of the invention an objective score of annoyance caused by noise in an audio signal; and

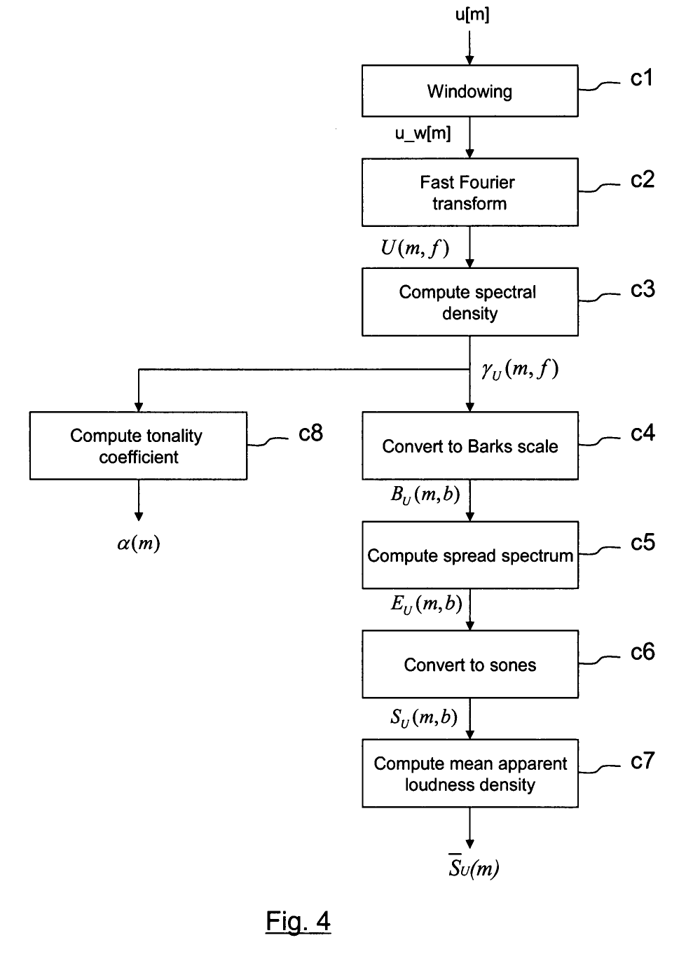

FIG. 4 is a flowchart illustrating computation in accordance with the invention of the mean apparent loudness density and the tonality coefficient of an audio signal frame.

Two embodiments of the method of the invention are described below, the first being applicable to an audio signal processed by a noise reduction function and the second being applicable to any noisy audio signal. The principle of the method of the invention is the same in both these embodiments, and in particular the computation method is exactly the same, but in the second embodiment the noisy signal is the audio signal after it has been processed by a noise reduction function. The second embodiment may be considered as a special case of the first embodiment, with the noise reduction function inhibited.

In the first embodiment of the method of the invention, the annoyance caused by noise in an audio signal processed by a noise reduction function is evaluated objectively in a test environment represented in FIG. 1. This kind of test environment includes an audio signal source SSA delivering a test audio signal x(n) containing only the wanted signal, that is to say containing no noise, for example a speech signal, and a noise source SB delivering a predefined noise signal.

For test purposes, this predefined noise signal is added to the selected test signal x(n), as represented by the addition operator AD. The audio signal xb(n) resulting from this addition of noise to the test signal x(n) is referred to as the “noisy signal”.

The noisy signal xb(n) then constitutes the input signal of a noise reduction module MRB implementing a noise reduction function delivering an audio output signal y(n) referred to as the “processed signal”. The processed signal y(n) is therefore an audio signal containing the wanted signal and residual noise.

The processed signal y(n) is then delivered to test equipment EQT implementing a method of the invention for objectively evaluating the annoyance caused by noise in the processed signal. The method of the invention is typically implemented in the test equipment EQT in the form of a computer program. The test equipment EQT may include, in addition to or instead of software means, electronic hardware means for implementing the method of the invention. In addition to the signal y(n), the test equipment EQT receives as input the test signal x(n) and the noisy signal xb(n).

The test equipment EQT delivers as output an evaluation result RES in the form of an objective score NOB_MOS of the annoyance caused by the noise in the processed signal y(n). The computation of this objective score NOB_MOS is described below.

The above audio signals x(n), xb(n) and y(n) are sampled signals in a digital format, n designating any sample. It is assumed that these signals are sampled at a sampling frequency of 8 kHz (kilohertz), for example.

In the embodiment described and represented here, the test signal x(n) is a speech signal free of noise. The noisy signal xb(n) represents the original voice signal x(n) degraded by a noisy environment (background noise or ambient noise) and the signal y(n) represents the signal xb(n) after noise reduction.

In one example of the use of the invention, the signal x(n) is generated in an anechoic chamber. However, the signal x(n) can also be generated in a “quiet” room having a “mean” reverberation time of less than half a second.

The noisy signal xb(n) is obtained by adding a predetermined noise contribution to the signal x(n). The signal y(n) is obtained either from a noise reduction algorithm installed on a personal computer or at the output of a noise reducer network equipment, in which case the signal y(n) is obtained from a PCM (pulse code modulation) coder.

In FIG. 2, the method of the invention for computing the objective score NOB_MOS of the annoyance caused by the noise in the processed signal y(n) is represented in the form of an algorithm including steps a1 to a7.

In a first step a1, the signals x(n), xb(n) and y(n) are divided into successive time windows called frames. Each signal frame, denoted m, contains a predetermined number of samples of the signal and the step al changes the timing of each of these signals. Changing the timing of the signals x(n), xb(n) and y(n) to the frame timing produces the signals x[m], xb[m] and y[m], respectively.

In a second step a2, voice activity detection is applied to the signal x[m] to determine if each respective current frame of index m of the signals xb[m] and y[m] is a frame containing only noise, denoted “m_noise”, or a frame containing speech, i.e. the wanted signal, denoted “m_speech”. This is determined by comparing the signals xb[m] and y[m] with the test signal x[m] free of noise. Each frame of silence in the signal x[m] corresponds to a noise frame of the signals xb[m] and y[m] and each speech frame of the signal x[m] corresponds to a speech frame of the signals xb[m] and y[m].

As represented in FIG. 2, on completion of the step a2, three types of frames are selected from the signals x[m], xb[m] and y[m]:
speech frames of the noisy signal xb[m], denoted xb[m_speech];
speech frames of the processed signal y[m], denoted y[m_speech];
noise frames of the processed signal y[m], denoted y[m_noise].

In a third step a3, apparent loudness measurements are effected at least on sets of frames y[m_noise], y[m_speech], xb[m_speech] obtained in the previous step a2 and a set of frames of the signal y[m] following the step a1. For example, if 8 seconds of test signal sampled at 8 kHz are used, it is possible to work on 250 frames y[m] of 256 samples of the signal y(n). Also, the tonality coefficients of at least one set of frames y[m_noise] are measured.

More precisely, in this step, the mean apparent loudness densities S̅_{Xb}(m_speech), S̅_{Y}(m_speech), S̅_{Y}(m) and S̅_{Y}(m_noise) of each of the respective frames xb[m_speech], y[m_speech], y[m] and y[m_noise] of the sets of frames considered are computed. Similarly, the tonality coefficients a_{Y}(m_noise) of each of the frames y[m_noise] of the set of frames y[m_noise] concerned are computed.

Computing a mean apparent loudness density S̅_{U}(m) and a tonality coefficient a(m) of a frame with any index m of a given audio signal u is described in detail below with reference to FIG. 4.

A fourth step a4 computes the respective mean values S̅_{Xb}_{_{—}}speech, S̅_{Y}_{_{—}}speech, S̅_{Y}, and S̅_{Y}_{_{—}}noise of the mean apparent loudness densities S̅_{Xb}(m_speech), S̅_{Y}(m_speech), S̅_{Y}(m) and S̅_{Y}(m_noise) previously computed over the respective sets of frames xb[m_speech], y[m_speech], y[m] and y[m_noise] concerned. The mean a_{Y}_{_{—}}noise of the tonality coefficients a_{Y}(m_noise) previously computed over the set of frames y[m_noise] concerned is also computed.

A fifth step a5 computes five factors, denoted factor(i) where i is an integer varying from 1 to 5, that are characteristic of the annoyance caused by the noise in the signal y(n), using the following formulas:

$$factor ( 1 ) = \frac{{\overline{S}}_{Y} \_noise}{{\overline{S}}_{Y}} ;$$

$$factor ( 2 ) = \frac{{\overline{S}}_{Y} \_noise}{{\overline{S}}_{Y} \_speech} ;$$

factor(3)=SD( S̅_{Sb}(m_speech)− S̅_{Y}(m_speech)), the operator “SD(v(m))” denoting the standard deviation of the variable v over the set of frames m;

factor(4)=a_{Y}_{_{—}}noise;

factor(5)=MSD(a_{Y}(m_noise)).

In a sixth step a6, an intermediate objective score NOB is computed by linear combination of the five factors computed in the step a5 using the following equation:

$$NOB = {\sum }_{i = 1}^{5} {ω}_{i} factor ( i ) + {ω}_{6}$$

in which the coefficients ω₁ to ω₆ are predefined weighting coefficients. These coefficients are determined to maximize the correlation between subjective data obtained from a subjective test database and the objective scores NOB computed by this linear combination using the test, noisy and processed signals x[m], xb[m] and y[m] used during those subjective tests. The subjective test database is a database of scores obtained with panels of listeners in accordance with ITU-T Recommendation P.835, for example, in which these scores are referred to as “background noise” scores.

Note that obtaining weighting coefficients using a subjective test database is not essential to each step of computing an objective score NOB. These coefficients must be obtained before the method is used for the first time and can be the same for all uses of the method. They can nevertheless evolve if new subjective data is fed into the subjective database used.

Finally, during a final step a7, an objective score NOB_MOS on the MOS scale of the annoyance caused by the noise in the processed signal y(n) is computed, for example using a third order polynomial function, from the following equation:

$$NOB\_MOS = {\sum }_{i = 1}^{4} {{λ}_{i} ( NOB )}^{i - 1}$$

in which the coefficients λ₁ to λ₄ are determined so that the objective score NOB_MOS obtained characterizes the annoyance caused by the noise on the MOS scale, i.e. on a scale of 1 to 5.

In a second embodiment of the method of the invention, the annoyance caused by noise in any noisy audio signal is evaluated objectively. The same test environment is used as in FIG. 1, but with the noise reduction module MRB removed. The audio signal source SSA delivers a test audio signal x(n) containing only the wanted signal, to which a predefined noise signal generated by the noise source SB is added to obtain downstream of the addition operator AD a noisy signal xb(n).

The test signal x(n) and the noisy signal xb(n) are then sent directly to the input of the test equipment EQT implementing the method of the invention for objective evaluation of the annoyance caused by the noise in the noisy signal xb(n). As in the first embodiment, the signals x(n) and xb(n) are assumed to be sampled at a sampling frequency of 8 kHz.

The test equipment EQT delivers as output an evaluation result RES in the form of an objective score NOB_MOS of the annoyance caused by the noise in the noisy signal xb(n).

Referring to FIG. 3, the method of the invention for computing the objective score NOB_MOS of the annoyance caused by the noise in the noisy signal xb(n) is represented in the form of an algorithm including steps b1 to b7. These steps are similar to the steps a1 to a7 described above for the first embodiment, and are therefore described in slightly less detail. Note that the second embodiment results if the computation steps a3 to a7 are applied with the signal y(n) equal to the signal xb(n) in the first embodiment.

In a first step b1, the signals x(n) and xb(n) are divided into frames x[m] and xb[m] with time index m.

In a second step b2, voice activity detection is applied to the signal x[m] to determine if each current frame of index m of the noisy signal xb[m] is a frame containing only noise, denoted “m_noise”, or a frame also containing speech, denoted “m_speech”. Thus two types of frames are selected from the signals x[m] and xb[m] on completion of the step b2:
speech frames of the noisy signal xb[m], denoted xb[m_speech]; and
noise frames of the noisy signal xb[m], denoted xb[m_noise].

In a third step b3, apparent loudness measurements are effected at least on sets of frames xb[m_noise] and xb[m_speech] from the previous step b2 and a set of frames of the signal xb[m] from the step b1. The tonality coefficients of at least one set of frames xb[m_noise] are also measured.

More precisely, in this step, the mean apparent loudness densities S̅_{Xb}(m), S̅_{Xb}(m_speech) and S̅_{Xb}(m_noise) of each of the respective frames xb[m], xb[m_speech] and xb[m_noise] of the sets of frames concerned are computed. Similarly, the tonality coefficients a_{Xb}(m_noise) of each of the frames xb[m_noise] of the set of frames xb[m_noise] concerned are computed.

In a fourth step b4, the respective mean values S̅_{Xb}, S̅_{Xb}_{_{—}}speech and S̅_{Xb}_{_{—}}noise of the mean apparent loudness densities S̅_{Xb}(m), S̅_{Xb}(m_speech) and S̅_{Xb}(m_noise) previously computed over the respective sets of frames xb[m], xb[m_speech] and xb[m_noise] concerned are computed. The mean a_{Xb}_{_{—}}noise of the tonality coefficients a_{Xb}(m_noise) previously computed over the set of frames xb[m_noise] is also computed.

In a fifth step b5, four factors, denoted factor(i) where i is an integer varying from 1 to 4, characteristic of the annoyance caused by the noise in the noisy signal xb(n) are computed using the following formulas:

$$factor ( 1 ) = \frac{{\overline{S}}_{Xb} \_noise}{{\overline{S}}_{Xb}} ;$$

$$factor ( 2 ) = \frac{{\overline{S}}_{Xb} \_noise}{{\overline{S}}_{Xb} \_speech} ;$$

$$factor ( 3 ) = {α}_{Xb} \_noise ;$$

factor(4)=SD(a_{Xb}(m_noise)), the operator “SD(v(m))” denoting the standard deviation of the variable v over the set of frames m.

In a sixth step b6, an intermediate objective score NOB is computed by linear combination of the four factors computed in the step b5, using the following equation:

$$NOB = {\sum }_{i = 1}^{4} {ω}_{i} factor ( i ) + {ω}_{5}$$

in which the coefficients ω₁ to ω₅ are predefined weighting coefficients. These coefficients are determined to maximize the correlation between subjective data from a subjective test database and the objective scores NOB computed by this linear combination using the test signals and the noisy signals x[m] and xb[m] used in those subjective tests. As for the step a6, obtaining weighting coefficients by using a subjective test database is not indispensable to each step of computing an objective score NOB.

Finally, in a final step b7, an objective score NOB_MOS on the MOS scale of the annoyance caused by the noise in the noisy signal xb(n) is computed, for example using a third order polynomial function, from the following equation:

$$NOB\_MOS = {\sum }_{i = 1}^{4} {{λ}_{i} ( NOB )}^{i - 1}$$

in which the coefficients λ₁ to λ₄ are determined so that the objective score NOB_MOS obtained characterizes the annoyance caused by the noise on the MOS scale, i.e. on a scale from 1 to 5.

Computation of the mean apparent loudness density and the tonality coefficient of an audio signal frame in accordance with a preferred embodiment of the invention in the steps a3 and b3 is described next with reference to FIG. 4.

Computation in accordance with the invention of the mean apparent loudness density S̅_{U}(m) of a frame with any index m of a given audio signal u[m] includes the steps c1 to c7 represented in FIG. 4 and described below. Computation in accordance with the invention of the tonality coefficient a(m) of a frame with any index m of a given audio signal u[m] includes the steps c1, c2, c3 and c8 represented in FIG. 4 and described below.

A frame with any index m of a signal u[m] is considered below, knowing that some or all of the frames of the signal concerned undergo the same processing. The signal u[m] represents any of the signals x[m], xb[m] or y[m] defined above.

In the first step c1, windowing is applied to the frame of index m of the signal u[m], for example Hanning, Hamming or equivalent type windowing. A windowed frame u_w[m] is then obtained.

In the next step c2, a fast Fourier transform (FFT) is applied to the windowed frame u_w[m] and a corresponding frame U(m,f) in the frequency domain is therefore obtained.

In the next step c3, the spectral power density γ_{U}(m,f) of the frame U(m,f) is computed. This kind of computation is known to the person skilled in the art and consequently is not described in detail here.

Following the step c3, for the signal y[m_noise] of the step a3 or the signal xb[m_noise] of the step b3, the next step is the step c8, for example, to compute the tonality coefficient, followed by the step c4 to compute the mean apparent loudness density S̅_{U}(m), since both computations are necessary for these two signals. For the other signals of the steps a3 and b3, the next step is the step c4 for computing the mean apparent loudness density S̅_{U}(m). Note that computing the tonality coefficient is independent of computing the mean apparent loudness density S̅_{U}(m), so the two computations can therefore be effected in parallel or one after the other.

In the step c4, the power spectral density γ_{U}(m,f) obtained in the previous step is converted from a frequency axis to a Barks scale, and a spectral power density B_{U}(m,b) on the Barks scale, also known as the Bark spectrum, is therefore obtained. For a sampling frequency of 8 kHz, 18 critical bands must be considered. This type of conversion is known to the person skilled in the art, the principle of this Hertz/Bark conversion consisting in adding all the frequency contributions present in the critical band of the Barks scale concerned.

Then, in the step c5, the power spectral density B_{U}(m,b) on the Barks scale is convoluted with the spreading function routinely used in psychoacoustics, and a spread spectral density E_{U}(m,b) on the Barks scale is therefore obtained. This spreading function has been formulated mathematically, and one possible expression for it is:

10log10(E(b))=15.81+7.5*(b+0.474)−17.5*{square root over ((1+(b+0.474)²))}

where E(b) is the spreading function applied to the critical band b on the Barks scale concerned and * symbolizes the multiplication operation in the space of real numbers. This step takes account of interaction of adjacent critical bands.

In the next step c6, the spread spectral density E_{U}(m,b) obtained previously is converted into apparent loudness densities expressed in sones. For this purpose the spread spectral density E_{U}(m,b) on the Barks scale is calibrated by the respective power scaling and apparent loudness scaling factors routinely used in psychoacoustics. Sections 10.2.1.3 and 10.2.1.4 of ITU-T Recommendation P.862 give an example of such calibration by the aforementioned factors. The value obtained is then converted to the phons scale. The conversion to the phons scale uses the equal loudness level contours (Fletcher contours) of the standard ISO 226 “Normal Equal Loudness Level Contours”. The magnitude previously converted into phons is then converted into sones in accordance with Zwicker's law, according to which:

$$N ( sones ) = 2 ( \frac{N ( phons ) - 40}{10} )$$

For more information on phons/sones conversion, see “PSYCHOACOUSTIQUE, L'oreille récepteur d'information” [“PSYCHOACOUSTICS, the information-receiving ear”], E. Zwicker and R. Feldtkeller, Masson, 1981.

Following the step c6, there is available a number B of apparent loudness density values S_{U}(m,b) of the frame with index m for the critical band b, where B is the number of critical bands on the Barks scale concerned and the index b varies from 1 to B.

Finally, in the step c7, the mean apparent loudness density S̅_{U}(m) of the frame with index m is computed from said B apparent loudness density values, using the following equation:

$${\overline{S}}_{U} ( m ) = \frac{1}{B} {\sum }_{b = 1}^{B} {S}_{U} ( m , b )$$

In other words, according to the invention, the mean apparent loudness density S̅_{U}(m) of a frame with index m is therefore the mean of the B apparent loudness density values S_{U}(m,b) of the frame with index m for the critical band b concerned.

These last two steps c6 and c7 correspond to conversion from the Barks domain to the Sones domain, for computing a mean subjective intensity, i.e. an intensity as perceived by the human ear.

Furthermore, in the step c8, the tonality coefficient a(m) of the frame with index m is computed using the following equation:

$$α ( m ) = \frac{10 * log 10 ( \frac{{( {\prod }_{f = 0}^{N - 1} {γ}_{U} ( m , f ) )}^{1 / N}}{\frac{1}{N} {\sum }_{f = 0}^{N - 1} {γ}_{U} ( m , f )} )}{- 60}$$

in which * symbolizes the multiplication operator in the real number space, f represents the frequency index of the spectral power density, and N designates the size of the fast Fourier transform. This computation is effected in accordance with the principle defined in the paper “Transform coding of audio signals using perceptual noise criteria”, J. D. Johnston, IEEE Journal on selected areas in communications, vol. 6, no. 2, February 1988.

The tonality coefficient a of a basic signal is a measurement indicating if certain pure frequencies exist in the signal. It is equivalent to a tonal density. The closer the tonality coefficient a to 0, the more similar the signal to noise. Conversely, the closer the tonality coefficient a to 1, the greater the majority tonal component of the signal. A tonality coefficient a closer to 1 therefore indicates the presence of wanted signal or speech signal.

1. A method of computing an objective score (NOB) of annoyance caused by noise in an audio signal processed by a noise reduction function, said method including a preliminary step of obtaining a predefined test audio signal (x[m]) containing a wanted signal free of noise, a noisy signal (xb[m]) obtained by adding a predefined noise signal to said test signal (x[m]), and a processed signal (y[m]) obtained by applying the noise reduction function to said noisy signal (xb[m]), wherein said method further includes a step (a3, a4) of measuring the apparent loudness of frames of said noisy signal (xb[m]) and said processed signal (y[m]) and of measuring tonality coefficients of frames of said processed signal (y[m]).

2. The method according to claim 1, comprising the steps of:
computing (a3) mean apparent loudness densities S̅_{Y}(m) of frames of the processed signal (y[m]), respective mean apparent loudness densities S̅_{Xb}(m_speech) and S̅_{Y}(m_speech) of frames of the wanted signal “m_speech” respectively of the noisy signal (xb[m]) and of the processed signal (y[m]), mean apparent loudness densities S̅_{Y}(m_noise) of noise frames “m_noise” of the processed signal (y[m]), and tonality coefficients a_{Y}(m_noise) of noise frames “m_noise” of the processed signal (y[m]); and
computing (a5, a6) an objective score (NOB) of annoyance caused by noise in the processed signal (y[m]) from said mean apparent loudness densities and said tonality coefficients that have been computed and predefined weighting coefficients.

3. The method according to claim 2, comprising the step (a3) of computing mean apparent loudness densities and tonality coefficients followed by a step (a4) of computing mean values S̅_{Y}, S̅_{Xb}_{_{—}}speech, S̅_{Y}_{_{—}}speech, S̅_{Y}_{_{—}}noise and a_{Y}_{_{—}}noise of said mean apparent loudness densities and said tonality coefficients over the set of frames concerned of the corresponding signals and the objective score (NOB) of annoyance caused by noise is computed using the following equation:
$$NOB = {\sum }_{i = 1}^{5} {ω}_{i} factor ( i ) + {ω}_{6}$$
$$where \text{:}$$
$$factor ( 1 ) = \frac{{\overline{S}}_{Y} \_noise}{{\overline{S}}_{Y}} ;$$
$$factor ( 2 ) = \frac{{\overline{S}}_{Y} \_noise}{{\overline{S}}_{Y} \_speech} ;$$
factor(3)=SD( S̅_{Xb}(m_speech)− S̅_{Y}(m_speech)), the operator “SD(v(m))” denoting the standard deviation of the variable v over the set of frames m;
factor(4)=a_{Y}_{_{—}}noise;
factor(5)=SD(a_{Y}(m_noise)); and
the coefficients ω₁ to ω₆ are determined to obtain a maximum correlation between subjective data obtained from a subjective test database and the objective scores (NOB) computed by said method of the test, noisy and processed signals x[m], xb[m] and y[m] used during said subjective tests.

4. A method of computing an objective score (NOB) of annoyance caused by noise in an audio signal, said method including a preliminary step of obtaining a predefined test audio signal (x[m]) containing a wanted signal free of noise and a noisy signal (xb[m]) obtained by adding a predefined noise signal to said test signal (x[m]), wherein said method includes a step (b3, b4) of measuring apparent loudness and tonality coefficients of frames of said noisy signal (xb[m]).

5. The method according to claim 4, comprising the steps of:
computing (b3) mean apparent loudness densities S̅_{Xb}(m) of frames of the noisy signal (xb[m]), mean apparent loudness densities S̅_{Xb}(m_speech) of wanted signal frames “m_speech” of the noisy signal (xb[m]), mean apparent loudness densities S_{Xb}(m_noise) of noise frames “m_noise” of the noisy signal (xb[m]), and tonality coefficients a_{Xb}(m_noise) of noise frames “m_noise” of the noisy signal (xb[m]); and
computing (b5, b6) an objective score (NOB) of annoyance caused by noise in the noisy signal (xb[m]) from said mean apparent loudness densities and said tonality coefficients that have been computed and predefined weighting coefficients.

6. The method according to claim 5, comprising the step (b3) of computing mean apparent loudness densities and tonality coefficients is followed by a step (b4) of computing mean values S̅_{Xb}, S̅_{Xb}_{_{—}}speech, S̅_{Xb}_{_{—}}noise and a_{Xb}_{_{—}}noise of said mean apparent loudness densities and said tonality coefficients over the set of frames concerned of the corresponding signals and said objective score (NOB) of annoyance caused by noise is computed using the following equation:
$$NOB = {\sum }_{i = 1}^{4} {ω}_{i} factor ( i ) + {ω}_{5}$$
$$in which$$
$$factor ( 1 ) = \frac{{\overline{S}}_{Xb} \_noise}{{\overline{S}}_{Xb}} ;$$
$$factor ( 2 ) = \frac{{\overline{S}}_{Xb} \_noise}{{\overline{S}}_{Xb} \_speech} ;$$
$$factor ( 3 ) = {α}_{Xb} \_noise ;$$
factor(4)=SD(a_{Xb}(m_noise)), the operator “SD(v(m))” denoting the standard deviation of the variable v over the set of frames m; and
the coefficients ω₁ to ω₅ are determined to maximize the correlation between subjective data obtained from a subjective test database and the objective scores (NOB) computed by said method of the test signals and the corresponding noisy signals x[m], xb[m] used in said subjective tests.

7. The method according to claim 1, wherein said step (a3, b3, a4, b4) of computing apparent loudness densities and tonality coefficients is preceded by a step (a2, b2) of detecting voice activity in the test signal to determine if a current frame with index m of the noisy signal (xb[m]) and of the process signal (y[m]) is a frame “m_noise” containing only noise, or a frame “m_speech” containing speech, called the wanted signal frame.

8. The method according to claim 1, wherein the step (a6, b6) of computing the objective score (NOB) is followed by a step (a7, b7) of computing an objective score (NOB_MOS) on the MOS scale of annoyance caused by noise using the following equation:
$$NOB\_MOS = {\sum }_{i = 1}^{4} {{λ}_{i} ( NOB )}^{i - 1}$$
in which the coefficients λ₁ to λ₄ are determined so that said new objective score (NOB_MOS) obtained characterizes annoyance caused by noise on the MOS scale.

9. The method according to claim 1, wherein in the step (a3, b3, a4, b4) of computing apparent loudness densities and tonality coefficients, computing the mean apparent loudness density S̅_{U}(m) of a frame with any index m of a given audio signal u includes the steps of:
windowing (c1), for example Hanning-type windowing, the frame with index m to obtain a windowed frame u_w[m];
applying (c2) a fast Fourier transform to the windowed frame u_w[m] to obtain a corresponding frame U(m,f) in the frequency domain;
computing (c3) the spectral power density γ_{U}(m,f) of the frame U(m,f);
converting (c4) the power spectral density γ_{U}(m,f) from a frequency axis to a Barks scale to obtain a spectral power density B_{U}(m,b) on the Barks scale;
convoluting (c5) the spectral power density B_{U}(m,b) on the Barks scale with the spreading function routinely used in psychoacoustics to obtain a spread spectral density E_{U}(m,b) on the Barks scale;
calibrating (c6) the spread spectral density E_{U}(m,b) on the Barks scale by respective power spreading and apparent loudness spreading factors routinely used in psychoacoustics, converting the magnitude thus obtained to the phons scale and then converting the magnitude previously converted into phons to the sones scale, and consequently obtaining a number B of apparent loudness density values S_{U}(m,b) of the frame with index m for the critical band b, where B is the number of critical bands concerned on the Barks scale and the index b varies from 1 to B; and
computing (c7) the mean apparent loudness density S̅_{U}(m) of the frame with index m from said B apparent loudness density values S_{U}(m,b), using the following equation:
$${\overline{S}}_{U} ( m ) = \frac{1}{B} {\sum }_{b = 1}^{B} {S}_{U} ( m , b )$$

10. The method according to claim 1, wherein in the step (a3, b3, a4, b4) of computing apparent power densities and tonality coefficients, computing the tonality coefficient a(m) of a frame with any index m of a given audio signal u includes the steps of:
windowing (c1), for example Hanning-type windowing, the frame with index m to obtain a windowed frame u_w[m];
applying (c2) a fast Fourier transform to the windowed frame u_w[m] to obtain a corresponding frame U(m,f) in the frequency domain;
computing (c3) the spectral power density γ_{U}(m,f) of the frame U(m,f); and
computing (c8) the tonality coefficient a(m) using the following equation:
$$α ( m ) = \frac{10 * log 10 ( \frac{{( {\prod }_{f = 0}^{N - 1} {γ}_{U} ( m , f ) )}^{1 / N}}{\frac{1}{N} {\sum }_{f = 0}^{N - 1} {γ}_{U} ( m , f )} )}{- 60}$$
in which * symbolizes the multiplication operator in the real number space, f represents the frequency index of the spectral power density, and N designates the size of the fast Fourier transform.

11. Test equipment for evaluating an objective score of annoyance caused by noise in an audio signal, comprising means adapted to implement a method according to claim 1.

12. Test equipment according to claim 11, comprising electronic data processing means and a computer program including instructions adapted to execute said method when it is executed by said electronic processing means.

13. A computer program on an information medium, comprising instructions adapted to execute a method according to claim 1 when the program is loaded into and executed in an electronic data processing system.

14. The method according to claim 4, wherein said step (a3, b3, a4, b4) of computing apparent loudness densities and tonality coefficients is preceded by a step (a2, b2) of detecting voice activity in the test signal to determine if a current frame with index m of the noisy signal (xb[m]) and of the process signal (y[m]) is a frame “m_noise” containing only noise, or a frame “m_speech” containing speech, called the wanted signal frame.

15. The method according to claim 4, wherein the step (a6, b6) of computing the objective score (NOB) is followed by a step (a7, b7) of computing an objective score (NOB_MOS) on the MOS scale of annoyance caused by noise using the following equation:
$$NOB\_MOS = {\sum }_{i = 1}^{4} {{λ}_{i} ( NOB )}^{i - 1}$$
in which the coefficients λ₁ to λ₄ are determined so that said new objective score (NOB_MOS) obtained characterizes annoyance caused by noise on the MOS scale.

16. A method according to claim 4, wherein in the step (a3, b3, a4, b4) of computing apparent loudness densities and tonality coefficients, computing the mean apparent loudness density S̅_{U}(m) of a frame with any index m of a given audio signal u includes the steps of:
windowing (c1), for example Hanning-type windowing, the frame with index m to obtain a windowed frame u_w[m];
applying (c2) a fast Fourier transform to the windowed frame u_w[m] to obtain a corresponding frame U(m,f) in the frequency domain;
computing (c3) the spectral power density γ_{U}(m,f) of the frame U(m,f);
converting (c4) the power spectral density γ_{U}(m,f) from a frequency axis to a Barks scale to obtain a spectral power density B_{U}(m,b) on the Barks scale;
convoluting (c5) the spectral power density B_{U}(m,b) on the Barks scale with the spreading function routinely used in psychoacoustics to obtain a spread spectral density E_{U}(m,b) on the Barks scale;
calibrating (c6) the spread spectral density E_{U}(m,b) on the Barks scale by respective power spreading and apparent loudness spreading factors routinely used in psychoacoustics, converting the magnitude thus obtained to the phons scale and then converting the magnitude previously converted into phons to the sones scale, and consequently obtaining a number B of apparent loudness density values S_{U}(m,b) of the frame with index m for the critical band b, where B is the number of critical bands concerned on the Barks scale and the index b varies from 1 to B; and
computing (c7) the mean apparent loudness density S̅_{U} (m) of the frame with index m from said B apparent loudness density values S_{U}(m,b), using the following equation:
$${\overline{S}}_{U} ( m ) = \frac{1}{B} {\sum }_{b = 1}^{B} {S}_{U} ( m , b )$$

17. The method according to claim 4, wherein in the step (a3, b3, a4, b4) of computing apparent power densities and tonality coefficients, computing the tonality coefficient a(m) of a frame with any index m of a given audio signal u includes the steps of:
windowing (c1), for example Hanning-type windowing, the frame with index m to obtain a windowed frame u_w[m];
applying (c2) a fast Fourier transform to the windowed frame u_w[m] to obtain a corresponding frame U(m,f) in the frequency domain;
computing (c3) the spectral power density γ_{U}(m,f) of the frame U(m,f); and
computing (c8) the tonality coefficient a(m) using the following equation:
$$α ( m ) = \frac{10 * log 10 ( \frac{{( {\prod }_{f = 0}^{N - 1} {γ}_{U} ( m , f ) )}^{1 / N}}{\frac{1}{N} {\sum }_{f = 0}^{N - 1} {γ}_{U} ( m , f )} )}{- 60}$$
in which * symbolizes the multiplication operator in the real number space, f represents the frequency index of the spectral power density, and N designates the size of the fast Fourier transform.

18. Test equipment for evaluating an objective score of annoyance caused by noise in an audio signal, comprising means adapted to implement a method according to claim 4.

19. Test equipment according to claim 18, comprising electronic data processing means and a computer program including instructions adapted to execute said method when it is executed by said electronic processing means.

20. A computer program on an information medium, comprising instructions adapted to execute a method according to claim 4 when the program is loaded into and executed in an electronic data processing system.
